(19) United States
(12) Patent Application Publication
(10) Pub. No.: US 2024/0037618 A1
(43) Pub. Date: Feb. 1, 2024

(54) SYSTEM AND PLATFORM FOR CREATING AND MANAGING FRACTIONALIZED NON-FUNGIBLE TOKENS

(71) Applicant: DILLON JAMES KORPMAN, NASHVILLE, TN (US)

(72) Inventor: DILLON JAMES KORPMAN, NASHVILLE, TN (US)

(21) Appl. No.: 18/131,844

(22) Filed: Apr. 6, 2023

Related U.S. Application Data
(60) Provisional application No. 63/328,185, filed on Apr. 6, 2022.
(60) Provisional application No. 63/443,383, filed on Feb. 4, 2023.

(51) Int. Cl. G06Q 30/0601; G06Q 30/0207

(52) U.S. Cl. CPC G06Q 30/0607; G06Q 30/0633; G06Q 30/0222; G06Q 2220/165

(57) ABSTRACT

A system and platform for dividing or fractionalizing a non-fungible token (NFT). An NFT is a unit of data stored of a digital ledger (e.g., blockchain) that certifies a digital asset to be unique and thus not interchangeable. The system provides for the creation or minting of a “PIE NFT” in a divisible format, which allows for the ability to sell, transfer, and/or purchase some or all of the NFT. A PIE NFT thus is fractionalized or divided into separate “PIE slices.” A platform is created to organize and store data (such as in a database) about one or more PIE NFTs.

This application claims benefit of and priority to U.S. Provisional App. No. 63/328,185, filed Apr. 6, 2022, and U.S. Provisional App. No. 63/443,383, filed Feb. 4, 2023, both of which are incorporated herein in their entireties by specific reference for all purposes.

### FIELD OF INVENTION

The present invention comprises a system and platform for creating and managing a divided or fractionalized non-fungible token (NFT). More particularly, the present invention comprises a system and platform for running and managing a fantasy game, such as a fantasy celebrity game, using or in conjunction with a system and platform for creating and managing a divided or fractionalized non-fungible token (NFT).

### BACKGROUND OF INVENTION

Non-fungible tokens (NFTs) are blockchain-based tokens, where each token represents a specific, unique asset (digital or physical). NFT assets include, but are not limited to, digital content, media, artwork, and the like. It can be considered to be an irrevocable digital certificate of ownership and/or authenticity for the associated assets. The NFT is a unique digital identifier recorded in a blockchain, and cannot be copied or substituted. The NFT is designed to be cryptographically verifiable and unique. The ownership of the NFT is recorded in the blockchain, and can be sold or transferred.

An NFT is created by a process called minting. This involves signing a blockchain transaction that outlines the basic token information, broadcasting this to the blockchain to trigger the creation of the token and assignment to the owner.

The nature and creation of NFTs are discussed in U.S. Pat. Pub. 20210256070, published Aug. 19, 2021 (Tran), and applications of NFTs in use with goods, digital assets and commerce are disclosed in U.S. Pat. No. 10,505,726, issued Dec. 10, 2019 (Andon, et al.); U.S. Pat. No. 10,673,619, issued Jun. 2, 2020 (Shi, et al.); U.S. Pat. No. 10,778,438, issued Sep. 15, 2020 (Shi, et al.); U.S. Pat. No. 11,308,184, issued Apr. 19, 2022 (Andon, et al.); and U.S. Pat. Pub. 20230079127, published Mar. 16, 2023 (Benedetto, et al.); all of which are which are incorporated herein in their entireties by specific reference for all purposes.

### SUMMARY OF INVENTION

The present invention comprises a system and platform for dividing or fractionalizing a non-fungible token (NFT). An NFT is a unit of data stored of a digital ledger (e.g., blockchain) that certifies a digital asset to be unique and thus not interchangeable. NFTs can be used to represent items or objects such as photos, videos, audio recordings, a digital personal, brand, digital files, digital art pieces, digital clothing, and other forms of digital assets. An NFT for an item or object can be both in a digital-only format and/or a digital format representing a tangible, physical item or object (e.g., a unique or one-of-a-kind painting or piece of art). The system includes a framework to govern and tie an on-chain asset (e.g., a digital asset) to an off-chain asset (e.g., a tangible, physical asset)

The present invention provides for the creation or minting of an NFT in a fractionalized or divisible format (“PIE NFT”), which allows for the ability to sell, transfer, and/or purchase some or all of the NFT. A PIE NFT thus is fractionalized or divided into separate “PIE slices” or “slices.”

The present invention further comprises a platform to organize and store data (such as in a database) about one or more PIE NFTs. When a creator of a PIE NFT (i.e., a “PIE Author”) creates or mints a PIE NFT, it gets added to the platform and database (or databases). The platform may be accessed by users through a variety of interfaces, including, but not limited to, a web browser or other user interface on a personal computer, laptop computer, tablet, mobile device, or other form of computing device. Users are able to search the database using the platform to identify and transact the buying/selling of PIE slices. A PIE Author's newly-minted PIE NFT is added to the platform and database(s), whereupon it becomes discoverable and searchable, and slices available for purchase by PIE Users, who are registered on the platform and system. Users are able to buy and/or sell PIE slices, and the system provides interfaces for users to place and complete order, or place future or contingent orders (e.g., an order may be triggered by a particular slice price).

### BRIEF DESCRIPTION OF THE DRAWINGS

FIGS. 1-4 show examples of pages for creating or minting a fractionalized NFT.

FIG. 5 shows an example of an author dashboard.

FIGS. 6-7 show examples of rewards center pages.

FIG. 8 shows an example of reward edit/creation page.

FIG. 9 shows an example of a reward achievement edit/creation page.

FIG. 10 shows an example of a trading page.

FIG. 11 shows an example of a user wallet page.

FIG. 12 shows another example of a trading page.

### DETAILED DESCRIPTION OF EXEMPLARY EMBODIMENTS

In various exemplary embodiments, the present invention comprises a system and platform for dividing or fractionalizing a non-fungible token (NFT). An NFT is a unit of data stored of a digital ledger (e.g., blockchain) that certifies a digital asset to be unique and thus not interchangeable. NFTs can be used to represent items or objects such as photos, videos, audio recordings, a digital personal, brand, digital files, digital art pieces, digital clothing, and other forms of digital assets. An NFT for an item or object can be both in a digital-only format and/or a digital format representing a tangible, physical item or object (e.g., a unique or one-of-a-kind painting or piece of art). The system includes a framework to govern and tie an on-chain asset (e.g., a digital asset) to an off-chain asset (e.g., a tangible, physical asset)

The present invention provides for the creation or minting of an NFT in a fractionalized or divisible format (“PIE NFT”), which allows for the ability to sell, transfer, and/or purchase some or all of the NFT. A PIE NFT thus is fractionalized or divided into separate “PIE slices” or “slices.”

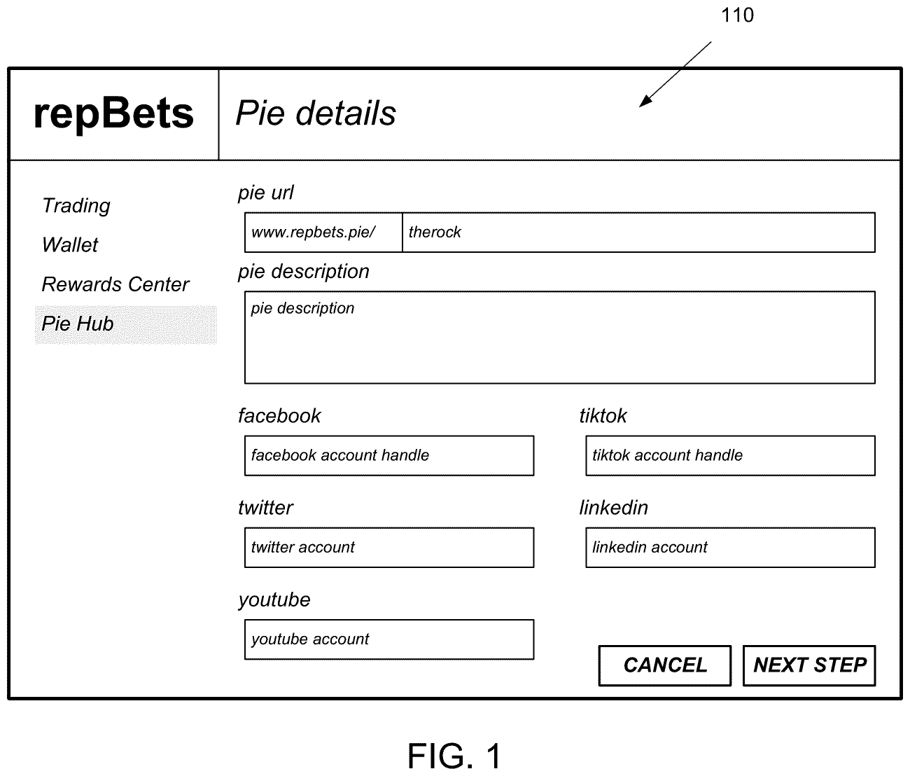

The present invention further comprises a platform to organize and store data (such as in a database) about one or more PIE NFTs. When a creator of a PIE NFT (i.e., a “PIE Author”) creates or mints a PIE NFT (as seen in FIG. 1), it gets added to the platform and database (or databases). The platform may be accessed by users through a variety of interfaces, including, but not limited to, a web browser or other user interface on a personal computer, laptop computer, tablet, mobile device, or other form of computing device. Users are able to search the database using the platform to identify and transact the buying/selling of PIE slices. A PIE Author's newly-minted PIE NFT is added to the platform and database(s), whereupon it becomes discoverable and searchable, and slices available for purchase by PIE Users, who are registered on the platform and system. Users are able to buy and/or sell PIE slices, and the system provides interfaces for users to place and complete order, or place future or contingent orders (e.g., an order may be triggered by a particular slice price) 510, 520.

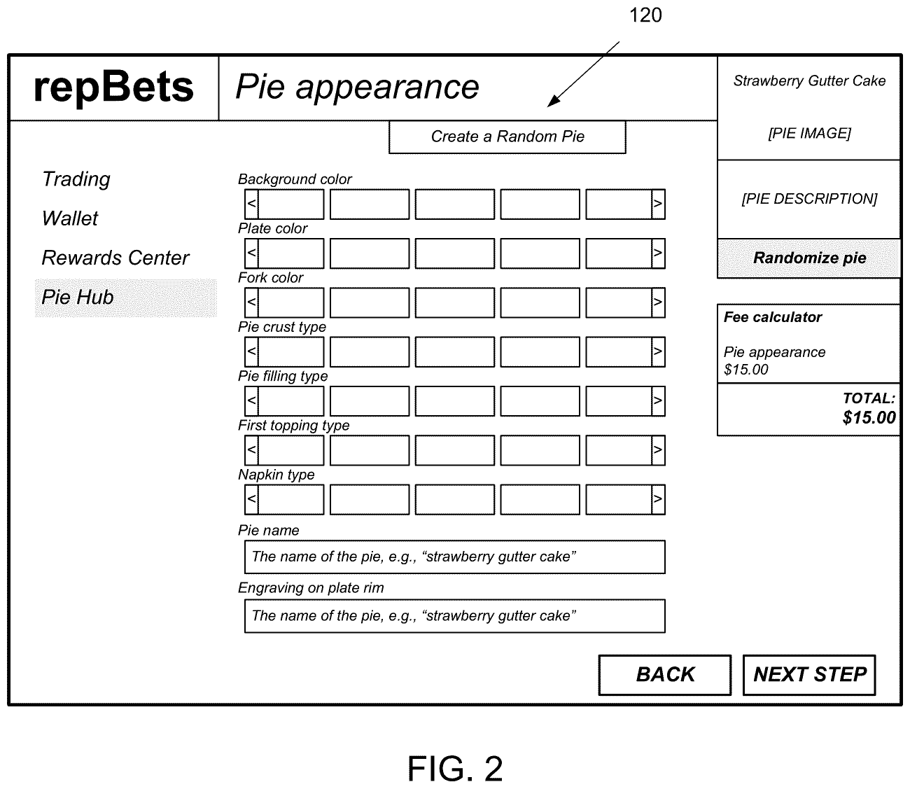

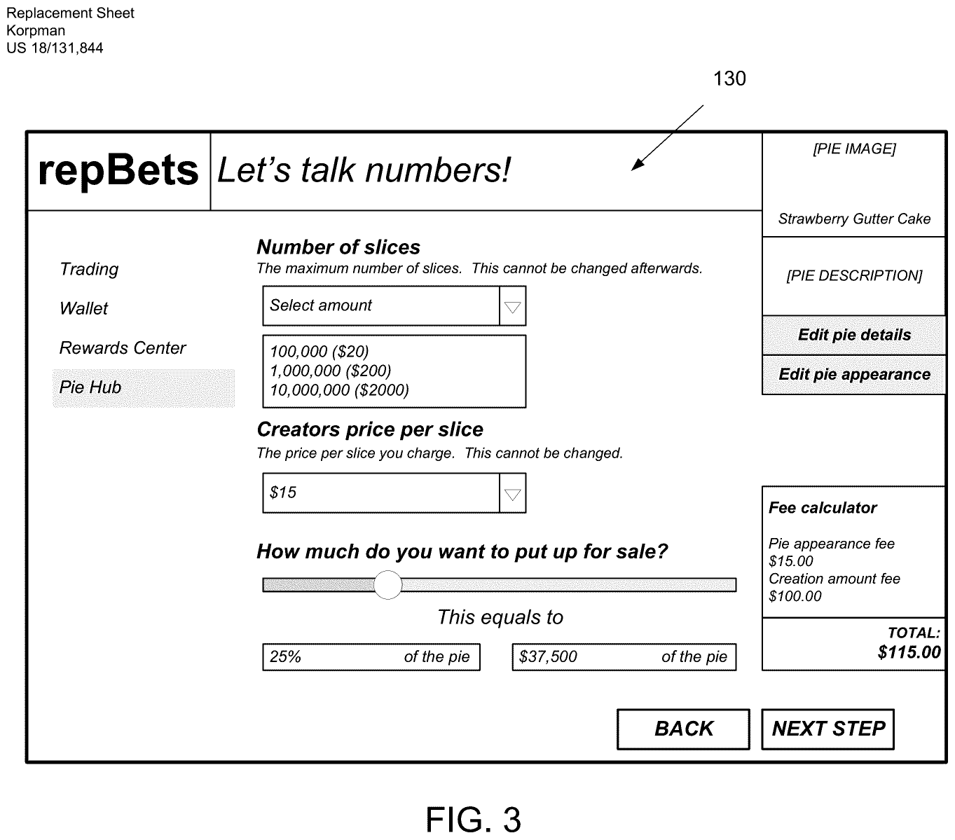

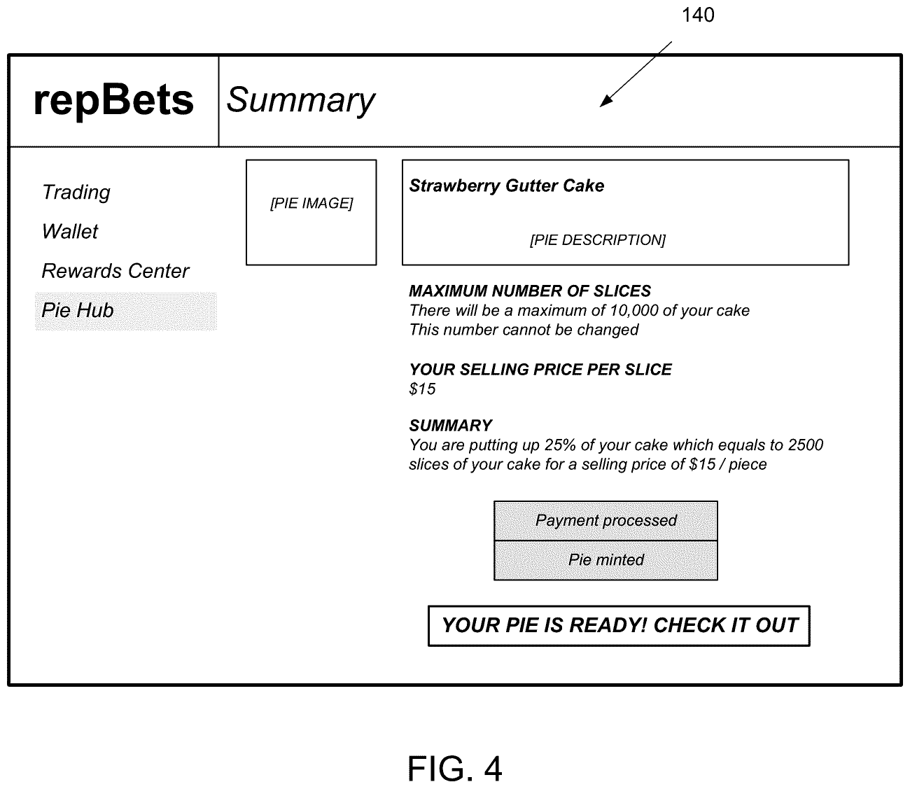

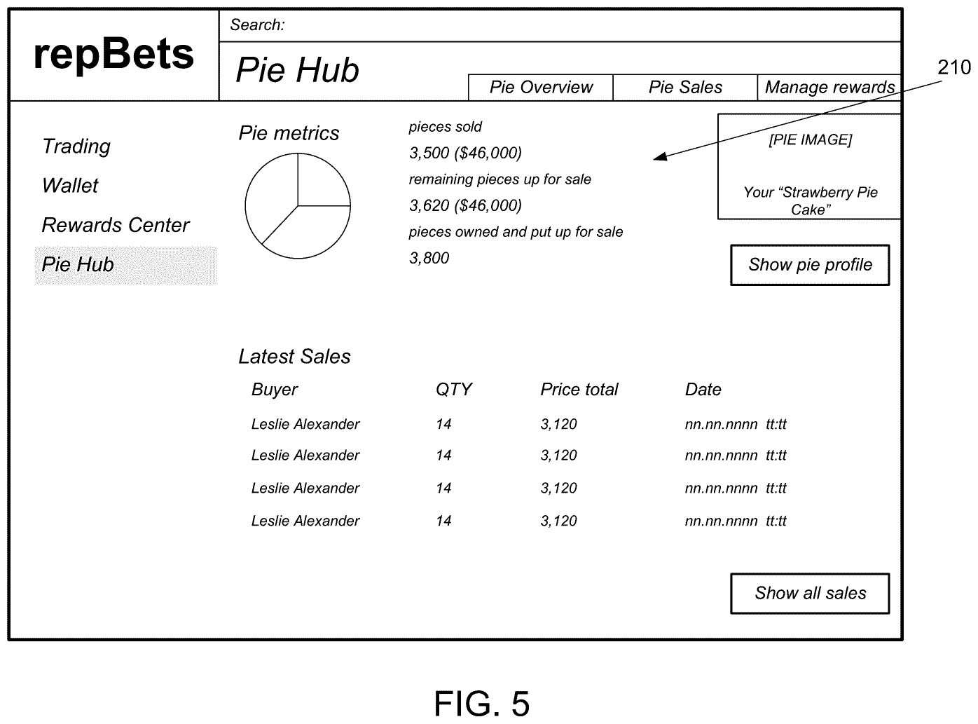

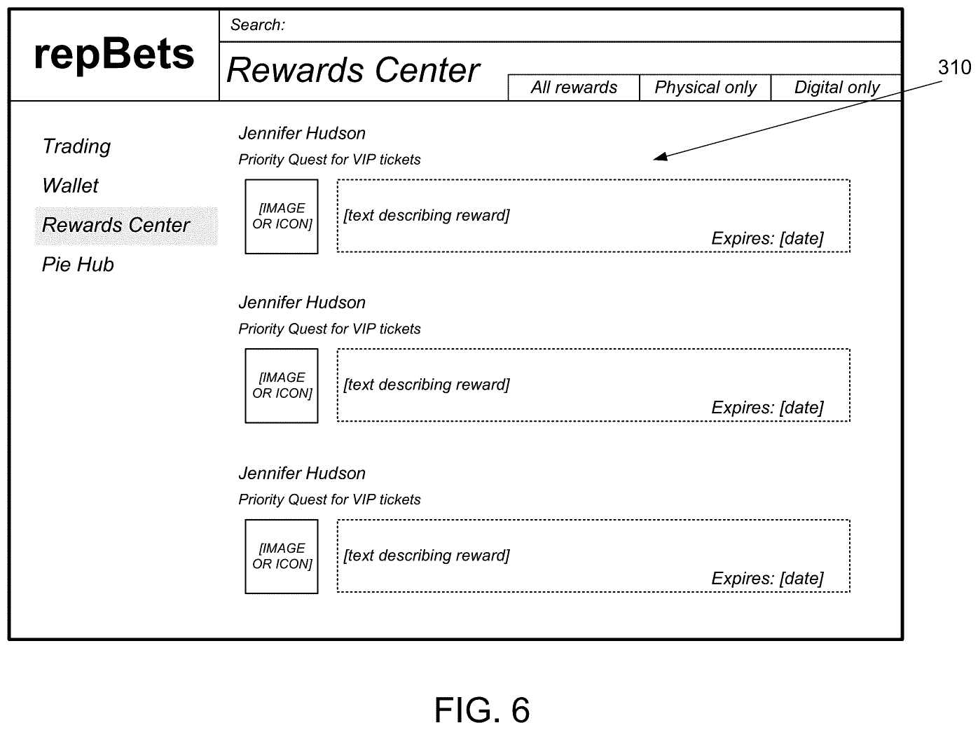

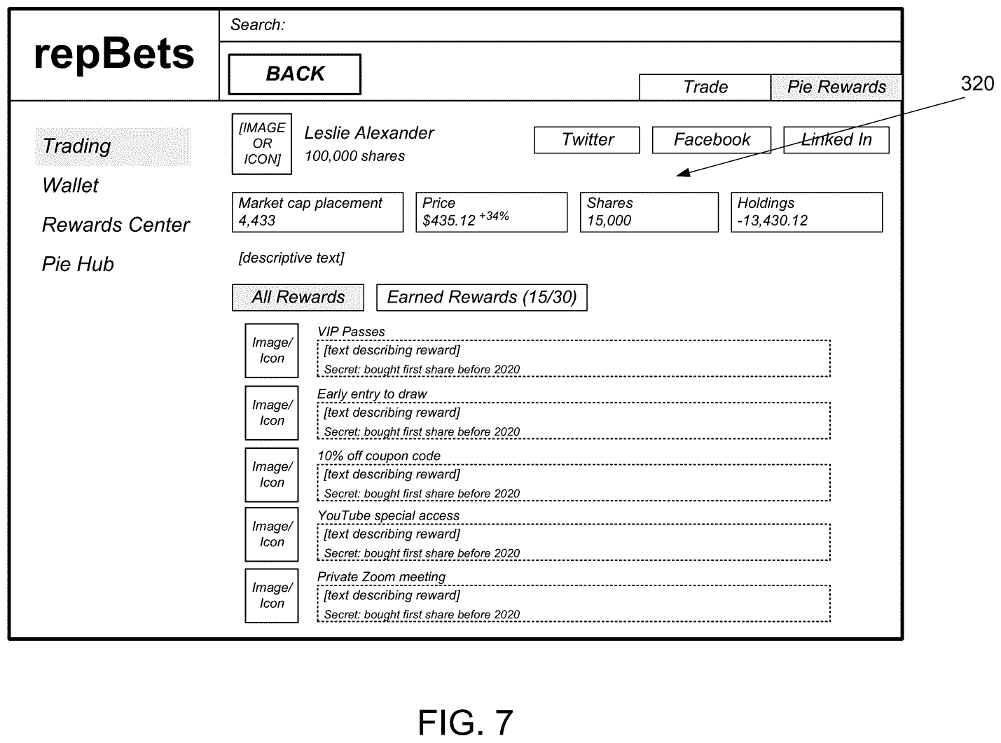

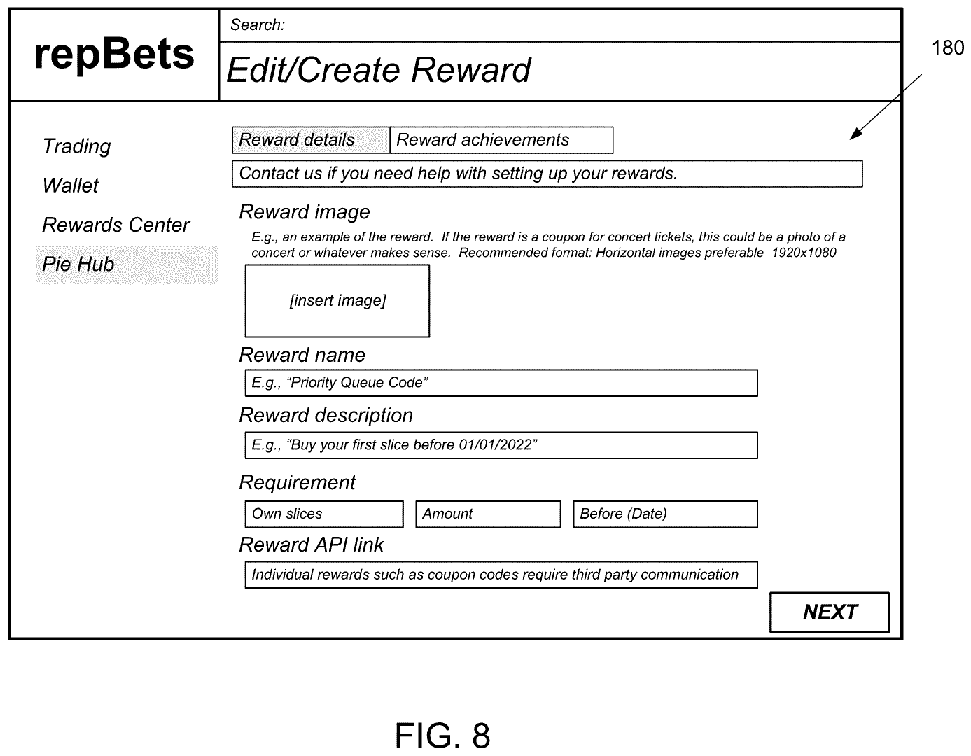

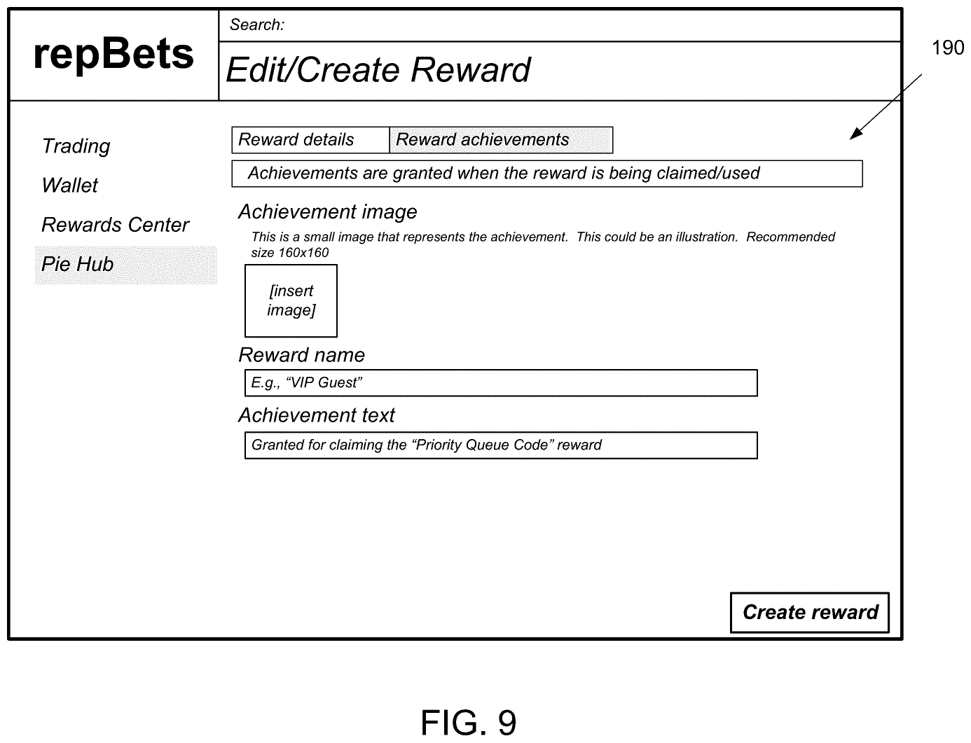

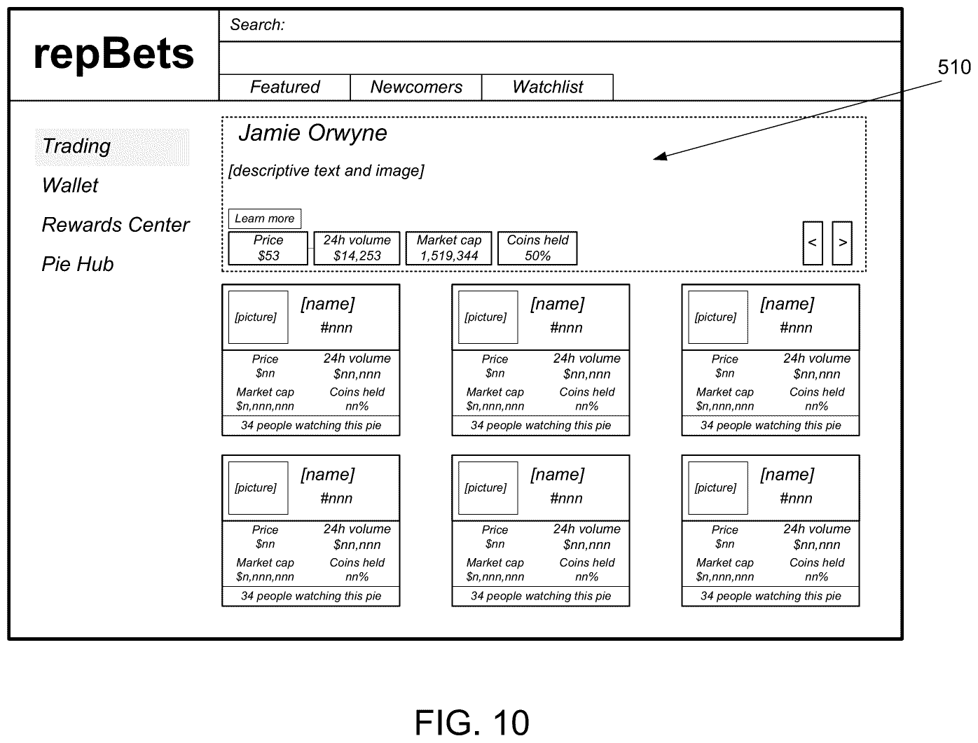

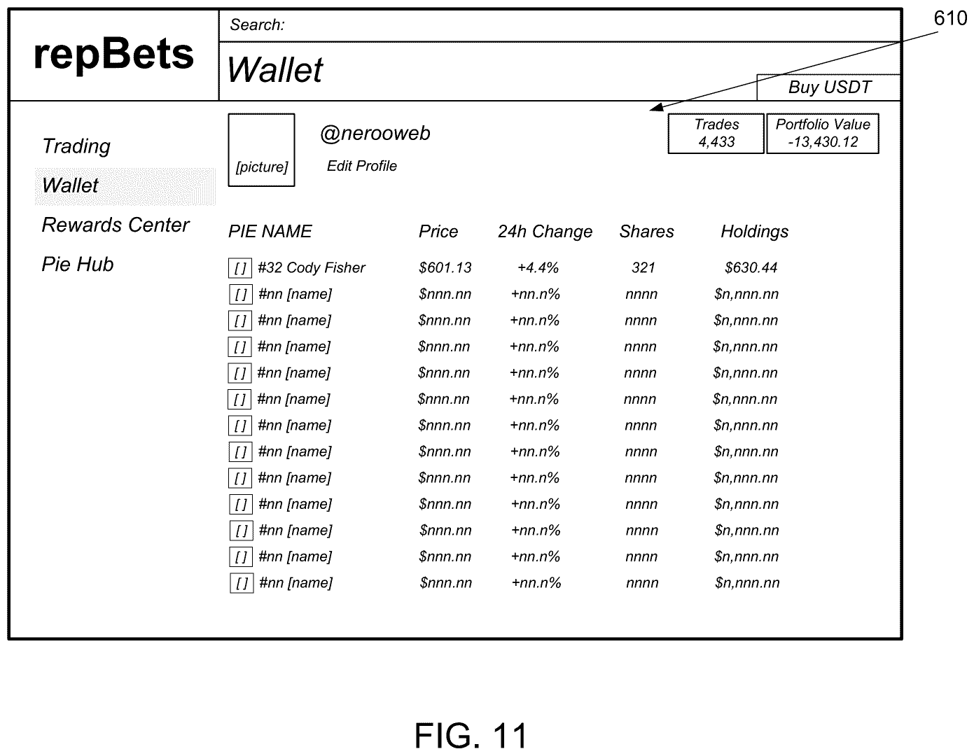

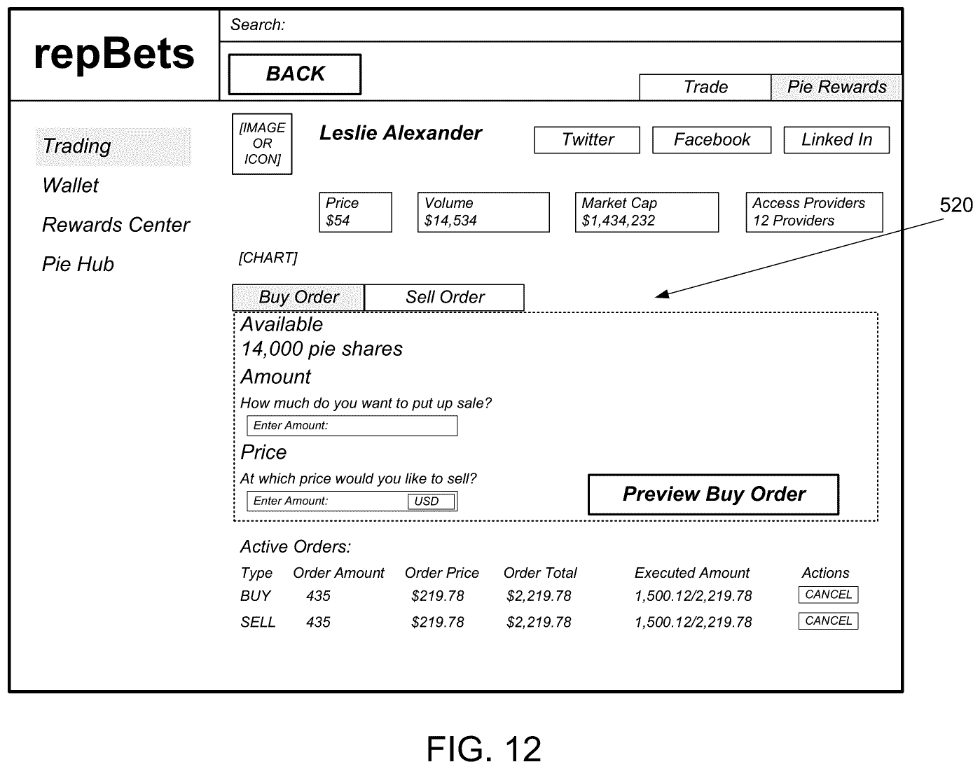

In several embodiments, the system comprises a real-time NFT generator (i.e., a “PIE Hub”), where a PIE Author can mint a PIE NFT. The PIE Hub may be a self-serve platform, where the author-user may choose the following attributes through a series of UI screens (see FIGS. 1-4), and the check-out with a payment through credit card, PayPal, cryptocurrency, or other similar payment means:
Physical attributes 120
Description 110
The total amount of slices 130
Price per slice 140
Slices available for sale 140
Slices to be designated for holding
Total Pie Value
Total Pie Cost
Pie Rewards 180
Pie Achievements 190
Maximum Slices of holdings
Pie Type (Person, Entity, Item)
   Flow Charts for Governance

The system includes features, policies, and procedures for PIE NFT governance, including, but not limited to:
Name change governance
Initial Market Period and who can participate and to what level
   Example allow max ownership, etc
Lock-in period and how it affects the credibility of the PIE
Under what conditions can a PIE be “closed”
Identity attributes and how they can be updated
   Sites
   Names
   Social Security Numbers
   Registration numbers
   Tax Ids
   Public Keys
   Etc
   Pie Burning
Unlock features and future offers such as invitations to purchase other PIEs and participate in events such as real-world events or online events

For authentication, the PIE system provides a unified way to authenticate current and past holdings of certain slices. For example, a website may require a user to hold a slice to be able to access its contents. The PIE system will authenticate that a user holds at least n slice(s) of a particular type. The PIE system can also authenticate a minimum age slice balance such as n slice(s) for a minimum of n month(s). This may be accomplished by co-signing a signed request from a user;
a. A user asserts access to a given resource or site.
b. The resource will challenge the user with conditions for access, such as holdings and age.
c. The user will sign the original request and thereby authenticate that identity.
d. PIE system will append user-associated facts and scopes that the original resources ask for and sign the response, validating that (1) the user identity is real, and (2) the requested conditions are true.

A PIE author may access an author dashboard UI (e.g., “Pie Hub”) 210 that displays and summarizes the author's total PIE holdings. The dashboard also allows an author to more easily visual current PIE value, slice market value, and buy/sell data respective to their slices. The author user also can review and manage rewards 310, 320 and achievements.

Rewards are benefits and offers that are available to users that hold various slices of PIE via their PIE wallet holdings. These rewards vary in type and can be similar to benefits/perks one might receive via membership clubs, credit card rewards, and the like Rewards thus may include, but are not limited to, the following: branded promotional discount codes, tickets or special access to digital or in person events, grant participation, drawing entries for sweepstakes and other games of chance, and access to digital and physical clubs.

Rewards can be generated in a variety of scenarios. One reward might be connected to a single PIE slice of a single PIE author or a combination of slices from multiple PIE authors. Rewards can be based on or utilize a single slice of PIE, multiple slices, or tiered amounts of slices used. A reward can be created by anyone for use by anyone. These offers are claimed in the user wallet via a QR code or a text to phone.

A Rewards Center on the platform displays all rewards that are available in digital and physical offers, presented by a user feed. The user can see the rewards that are offered to him or her based on the slices they hold per PIE. The user can organize their rewards based on whether they are offline or online experiences. For example, User A owns slices of PIE-Author 1 and PIE-Author 2. PIE-Author 1 and PIE-Author 2 have partnerships with Brand A and Brand B, respectively, and have created rewards for PIE holders. Brand A's and Brand B's rewards are presented to User A in the Rewards Center. Once a reward has been used via online or offline consumption, the reward then becomes an “earned reward” noted in User A's Profile.

The system also provides for awarding and tracking of achievements, which are recorded with the profile of PIE slice holders. These achievements are proof of awarded actions and are able to be used as identity reference points on other platforms. For example, PIE Author A sets an achievement of “Day 1 Supporter” that will be awarded to all slice holders that attend a specific concert show of the author's choosing. The slice holders activate the achievement by attending the event and scanning the QR code that identifies they are slice holders. The slice holders have the event time stamped onto their system profile and unlock the “Day 1 Supporter” achievement. The PIE author(s) or others can make special events or privileges available to PIE slice holders who have specific achievements. These include, but are not limited to, VIP tickets at a future event, or a special zoom event meet and greet, or a fan club page owner might allow people with this achievement assist in page moderating. The achievements can be verified through the system's o-authentication/identity system.

Rewards and achievements may span multiple PIEs. Thus, PIE authors, collaborators, partners and users are able to develop and choose the parameters on how to provide access to offers and design accomplishment badges for PIE holders in a SAAS offering.

The system also provides to users a compliant wallet 610 that can manage and interact with all of the system's hosted assets, both on and off chain. It operates under both delegated and direct encrypted modes, meaning either the system hosts the user's keys protected by the user's password and authentication, or the user hosts his or her own keys on either a hardware or software wallet.

In several embodiments, the system includes a verification system, similar to verification systems (e.g., blue check marks) available on many social platforms. By offering a “blue checkmark” or other verification indicia for verified PIE authors, users are quickly able to see that the PIE NFT they are viewing 510 is, or is associated with, a verified celebrity, individual, influencer, brand, item, or the like. This may be accomplished using a form of customer identification, verification, and/or due diligence (collectively referred to as “Know Your Customer” or KYC), as well as by synchronizing with social media sites and authenticating through secure login portals (e.g., FaceBook, Twitter, LinkedIn, Tiktok, YouTube, and the like).

The above-described invention may be used as a platform for creating, operating, and manage one or more games, including, but not limited to, a fantasy celebrity game. While this embodiment of the invention is described below in the context of a fantasy celebrity game, it can be used for a myriad of similar or related games or game-like systems or interactions.

The fantasy celebrity game (hereinafter the “Game”) provides a unique and exciting way for players to draft, manage, and compete with teams of celebrities and influencers. The system provides an engaging and dynamic platform for fans of celebrities and influencers to come together and compete in a fun and exciting way. The Game may be hosted on a website and associated mobile application(s). Game systems include a user registration and login system, a draft system, a scoring system that takes into account various metrics such as, but not limited to, social media following, box office performance, album sales, engagement rate on their posts, online engagement metrics, and appearances in various forms of media (such as TV shows, podcasts and others).

Users are able to compete against each other in a league or head-to-head format, and participate in online chat and discussion about the Game. The Game may promoted to attract a large user base and generate revenue through in-game purchases, as well as using a subscription-based model for some versions. Regular updates to the scoring system and player statistics are provided to reflect the celebrity's or influencer's real-life performance and activity. The game also may integrate with social media platforms, and possess features like push notifications for events and updates.

In several embodiments, the Game proceeds in periods of time referred to as “seasons.” A list of celebrities and influencers that are included and available in a season within the Game is compiled. This list includes a variety (e.g., 250, 500, or 1000 or more) of celebrities and influencers from different industries, such as, but not limited to, actors, musicians, athletes, and influencers with a large following on social media platforms. The Game and upcoming Game seasons are promoted in appropriate venues and forums to attract a large user/player base.

A website and/or or mobile app(s) are used to host and/or interface with the Game. This includes a user/player registration and login system, as well as a dashboard for managing and drafting teams. A draft system allows users to select their team of celebrities and influencers. This can be a snake draft, auction draft, or any other type of draft. A trade/acquisition system enables users to make trades and acquisitions of celebrities/influencers during the season.

Users/players compete against each other, through a league system and/or head-to-head matchups, based on the users' respective celebrities/influencers. A schedule of matchups for a Game season is created. This can be based on a variety of factors, such as, but not limited to, the celebrity's or influencer's upcoming projects or events.

A scoring system is used to determine the winner of each matchup within the Game. This may include a variety of factors, such as, but not limited to, social media following, box office performance, album sales, engagement rate on their posts, online engagement metrics, and appearances in media such as TV shows, podcasts and others. The scoring system and player statistics are periodically and regularly updated to reflect the celebrity's or influencer's real-life performance and activity.

The Game platform provides standing and/or statistics through one or more user interfaces or web pages. This may be done on a real time basis. Users may participate in online chat and discussion forums about the Game and elements of the Game, such as upcoming match-ups and/or results. Users may also use online chat and forums, or social media, to post and view standings and statistics.

Components and elements of the Game include the following:
Database system to store user information, team information, and player statistics
User registration and login system
Draft system for team formation
Scoring system that takes into account various metrics for each player
Trade and acquisition system
Matchup scheduling system
League and head-to-head matchup system
Live scoring and stats tracking system
Online chat and discussion forum
User dashboard for managing teams and viewing standings and statistics
Mobile app version for the game
Data scraping and scanning tools for gathering player statistics and information
   Examples:
      Instagram Scanner
      Twitter Scanner
      YouTube Scanner
      Spotify Postcast Scanner
      IMDB Scanner
      Reddit Scanner
      Classic Media Mentions Scanner (possible partner)
   Validity and anti-cheating countermeasures, possibly use 3rd parties to validate metrics per season.
Push notifications for events and updates
Integration with social media platforms
Payment gateway for in-game purchases and subscription-based model if required

The Game may be built on the fractionalized NFT system described above. Users/players pay a variety of fees at different points to participate in the Game and/or Game season. Fees included, but are not limited to, draft fees, management fees, and pool fees. Various pools, fees and prices may be expressed in US dollars (or other currency) and/or Pie slices.

In one embodiment, an association and membership group for a Game (or Games) is created. Users/players apply to the association and membership group, and once approved, are admitted as members and are added to the league roster. As such, players may participate in certain levels of Games or related events. A certain number of top social media accounts (e.g., the top 5000 accounts) are periodically eligible for a special or fantasy league. Similarly, a certain number of top performing players (measured in various ways, such as the 1000 top accounts, top performing Pies, or top clout users) are periodically eligible for a special or fantasy league. Players can stake their Pie slices as position for entry in such leagues.

Accordingly, the present invention creates an engaging and dynamic platform for fans of celebrities and influences to come together to compete in a fun and exciting way.

These embodiments, as well as other exemplary embodiments, as well as the tools and programs referenced above, are described in detail in the appendix hereto and incorporated herein in its entirety.

In order to provide a context for the various computer-implemented aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), tablets, smart phones, touch screen devices, smart TV, internet enabled appliances, internet enabled security systems, internet enabled gaming systems, internet enabled watches; internet enabled cars (or transportation), network PCs, minicomputers, mainframe computers, embedded systems, virtual systems, distributed computing environments, streaming environments, volatile environments, and the like.

Embodiments of the invention may be implemented in the form of computer-executable instructions, such as program code or program modules, being executed by a computer, virtual computer, or computing device. Program code or modules may include programs, objects, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices such as, but not limited to, hard drives, solid state drives (SSD), flash drives, USB drives, optical drives, and internet-based storage (e.g., “cloud” storage).

In one embodiment, a computer system comprises multiple client devices in communication with one or more server devices through or over a network, although in some cases no server device is used. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein.

Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C #, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, 15but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A system for generating and managing cryptographic assets, comprising:
at least one non-transitory computer-readable medium that comprises instructions executable by at least one processor to:
identify a first asset; and
mint a non-fungible token (NFT) in a fractionalized format with a plurality of slices, wherein the NFT is associated with and represents the first asset;
further wherein the minting process comprises the setting of at least the following attributes for the NFT: identity and/or description of the first asset; the total number of slices; the total NFT value; the initial price per slice; the number of slices available for sale; and the number of slices designated for holding.

2. The system of claim 1, wherein the NFT attributes are stored in a database associated with a platform in electronic communication over a network with the at least one processor.

3. The system of claim 2, wherein the database stores a plurality of fractionalized NFTs, and the platform is accessible by one or more users through a user interface which provides a search function.

4. The system of claim 3, wherein said one or more users are able to buy and/or sell slices of one or more of said plurality of fractionalized NFTs.

5. The system of claim 4, wherein a user can submit a contingent purchase order to buy one or more slices from a particular fractionalized NFT.

6. The system of claim 5, wherein the contingent purchase order is triggered by a particular slice price for said particular fractionalized NFT.

7. The system of claim 1, further comprising a controlled-access website, where access to the website is limited to users holding a predetermined minimum number of slices of a selected fractionalized NFT.

8. The system of claim 3, wherein the platform user interface comprises an author dashboard for authors who mint fractionalized NFTs.

9. The system of claim 1, wherein the fractionalized NFT attributes further comprise identification of rewards available to users holding one or more slices of the fractionalized NFT.

10. The system of claim 9, wherein said rewards comprise at least one of the following: discounts codes; tickets to digital or in-person events; or access to digital and/or physical clubs.

11. The system of claim 1, wherein the fractionalized NFT attributes further comprise identification of achievements available to users holding one or more slices of the fractionalized NFT who also perform a particular action associated with a particular achievement.

12. The system of claim 1, wherein the fractionalized NFTs comprise elements of a game.

13. The system of claim 12, wherein the game is an online fantasy celebrity game with a plurality of players, wherein each player from said plurality of players select a team roster of a predetermined size from a list of celebrities and social media influencers.

14. The system of claim 12, wherein said plurality of players compete through matchups of one or more individuals from their respective team rosters, where the winner or winners of each matchup are determined by one or more of the following real-life parameters for the individuals in said matchups: social media following; box office performance; album sales; post engagement rate; and media appearances.
